(19) United States
(12) Patent Application Publication
(10) Pub. No.: US 2015/0339723 A1
(43) Pub. Date: Nov. 26, 2015

(54) USER-BASED ANALYSIS OF ADVERTISEMENT POOLS

(71) Applicant: SHARED2YOU, INC., Eden Prairie, MN (US)

(72) Inventors: Brett E. BAUER, Eden Prairie, MN (US); Kenneth J. ROBINSON, Eden Prairie, MN (US); Ed WILLIAMS, Yankton, SD (US); Andy MELTZER, Mendota Heights, MN (US)

(21) Appl. No.: 14/758,441

(22) PCT Filed: Dec. 31, 2013
(86) PCT No.: PCT/US13/78480

§ 371 Date: Jun. 29, 2015

Related U.S. Application Data
(60) Provisional application No. 61/748,257, filed on Jan. 2, 2013.

(51) Int. Cl. G06Q 30/02; H04M 1/725

(52) U.S. Cl. CPC G06Q 30/0267; H04M 1/72522

(57) ABSTRACT

In at least one embodiment, a method comprises receiving data associated with one or more user computing devices, wherein the data comprises the identity of a application stored on one or more of the one or more user computing devices; receiving a pool of advertisements, wherein an advertisement in the pool of advertisements comprises advertisement information associated with the advertisement; analyzing the data, the pool of advertisements, and the advertisement information to identify one or more suitable advertisements for presentation to the one or more of the one or more user computing devices; and sending information comprising an identification of the suitable advertisement.

### FIELD OF THE INVENTION

Embodiments in the present disclosure generally relate to computing device advertisement selection. Mole specifically, embodiments relate to user device centric advertisement selection and analysis of relationships between actions taken at a user device and the probability of an advertisement being clicked on.

### BACKGROUND OF THE INVENTION

Software applications (also referred to herein as “apps”) for mobile computing devices, such as mobile phones and tablets, have become increasingly popular as the capabilities of these devices continue to develop. Apps have become so popular that “app store” economies were created by multiple providers and for multiple computing platforms. For example, Apple®, Google®, Amazon® and others each operate their own app stores. The number of apps created and downloaded is projected to increase significantly for the foreseeable future. Certain applications can be downloaded for free, while others must be purchased.

Many applications include features that allow advertisers to display advertisements to an application user. These advertisements are often associated with other applications, for example an advertisement may advertise a different game application. When a user clicks on the advertisement, they can temporarily be taken to a new screen that allows them to download the advertised application. Advertisers often generate income based on the number of users that click though their advertisement and download an application.

Because of increased popularity of software applications, a wide array of people are using mobile computing devices to access and use these software applications. As their popularity continues to increase, it is becoming harder and harder for advertisers to determine what advertisements will resonate with the viewing audience. Advertisements that resonate with a 15 year old playing a game may not resonate with a 45 year old trying to complete a business transaction. As users are presented with more numerous advertisements that do not interest them, they learn to ignore advertisements in general, reducing the likelihood that they will even click on advertisements that may interest them.

Thus, while the number of users of mobile computing devices increases, and advertisers continue to promote applications that interest only subsets of the total user population, the effectiveness of current advertisement methodologies continues to decrease. Thus, it would be advantageous to develop ways to target advertisements for specific users or groups of users.

### SUMMARY OF THE INVENTION

In at least one embodiment, a method includes the steps of receiving, data associated with one or more user computing devices, wherein the data comprises the identity of a application stored on one or more of the one or more user computing devices; receiving a pool of advertisements, wherein an advertisement in the pool of advertisements comprises advertisement information associated with the advertisement; analyzing the data, the pool of advertisements, and the advertisement, information to identify one or more suitable advertisements for presentation to the one or more of the one or more user computing devices; and sending information comprising an identification of the suitable advertisement.

In at least one embodiment, a device comprises an analysis engine and an advertisement list generation module. The analysis engine can be configured to receive user data and a pool of advertisements, and determine a score for one or more advertisements in the pool of advertisements, wherein the pool of advertisements comprises the one or more advertisements and additional information for one or more of the one or more advertisements. The advertisement list generation module can be configured to receive a pool of advertisements and generate a targeted list of advertisements based on the score of the one or more advertisements.

### BRIEF DESCRIPTION OF THE DRAWINGS

The novel features believed characteristic of the invention are set forth in the appended claims. However, the invention, as well as, a preferred mode of use, will best be understood by reference to the following detailed description of an illustrative embodiment when read in conjunction with the accompanying drawings, wherein:

FIG. 1 is a block diagram of an exemplary environment in which the present invention may be practiced.

FIG. 2 is a block diagram of an exemplary user-based analysis system in which the present invention may be practiced.

FIG. 3 is a flowchart illustrating a process for creating an ordered list of advertisements, according to an, example embodiment.

FIG. 4 is a block diagram of an exemplary environment in which the present invention may be practiced.

FIG. 5 is a block diagram of an exemplary environment in which the present invention may be practiced.

FIG. 6 is a block diagram of an exemplary set of core functions of an application-sharing-application, according to an example embodiment.

FIG. 7 is a flowchart illustrating a process for setting up an account for an application-sharing-application, according to an example embodiment.

FIG. 8 is a flowchart illustrating, a process for determining which applications are shared in an application-sharing-application, according to an example embodiment.

FIG. 9 is a flowchart illustrating a process for recommending applications to be shared in an application-sharing-application, according to an example embodiment.

FIG. 10 is a flowchart illustrating a process for creating a collection of applications to be shared in an application-sharing-application, according to an example embodiment.

FIG. 11 is a flowchart illustrating a process for discovering new applications or collections in an application-sharing-application, according, to an example embodiment.

### DETAILED DESCRIPTION

While the disclosure refers to illustrative embodiments for particular applications, it should be understood that the disclosure is not limited thereto. Modifications can be made to the embodiments described herein without departing from the spirit, and scope of the present disclosure. Those skilled in the art with access to this disclosure will recognize additional modifications, applications, and embodiments within the scope of this disclosure and additional fields in which the disclosed examples could be applied. Therefore, the following detailed description is not meant to be limiting. Further, it is understood that the systems and methods described below can be implemented in many different embodiments of hardware or software. Any actual hardware or software described is not meant to be limiting. The operation and behavior of the systems and methods presented are described with the understanding that modifications and variations of the embodiments are possible given the level of detail presented. For example, locations of certain features described within this disclosure are not meant to be limiting.

References to “one embodiment,” “an embodiment,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

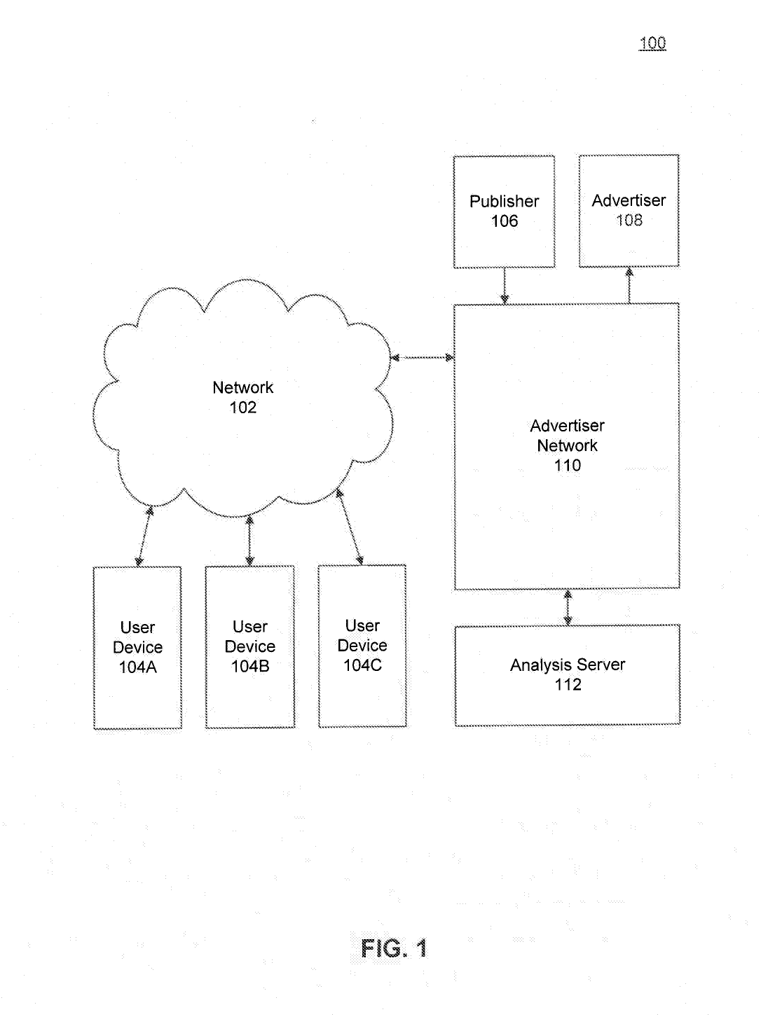

With reference now to the figures, and in particular with reference to FIGS. 1, 4, and 5, there is depicted an exemplary embodiment of an environment in which the methods, systems, and program products of the present invention may advantageously be practiced. In particular, FIG. 1 illustrates an environment 100 comprising user devices 104A-C, network 102, publisher 106, advertiser 108, advertiser network 110, and analysis server 112.

In an embodiment, network 102 can be configured to allow various computing devices to communicate. For example, network 102 can allow one or more user devices 104A-C to communicate with the advertiser network 110. In an embodiment, network 102 is the Internet. In another embodiment, network 102 is a cloud service provider.

User devices 104A-C are computing devices configured to communicate with network 102. For example, user devices 104A-C can be personal computers, laptops, cell phones, tablets, television sets, wearable computing devices, etc. Certain embodiments of the present invention relate to “mobile” devices, such as laptops, cell phones, tablets or wearable computing devices. However, it should be understood that other embodiments of the applications disclosed herein can be used with any computing device, mobile or otherwise.

In an embodiment, user devices can be configured to download one or more applications from application publishers. The terms “software application,” “application,” and “app” are used interchangeably herein, and broadly relate to application software that can be executed by a computing device. Applications provide users with the ability to use a computing device in a variety of manners, for example to play games; create, modify, and publish documents; manage business; communicate with users on other computing devices; watch videos; listen to music; manage personal information; conduct financial transactions; etc. Applications can also be configured to present users of the computing device with advertisements for a variety of products and services, including advertisements for other applications. The advertisements can be configured to provide the application developer with additional streams of revenue.

Applications may include, but are not limited to, business, games, health, medical, music, news, photography, computing device setup/settings, computing device optimization, social networking, sports, travel, or video applications. Applications can come pre-installed on a computing device, they can be downloaded from a network, for example the Internet or a cloud computing service, they can be installed through a peripheral device, etc.

In an embodiment, one or more advertisements may be presented to a user during execution of an application. An online advertising network, or advertiser network 110, is a service that connects advertisers and publishers with other parties that want to host advertisements. The key function of an advertiser network is aggregation of advertisements supplied by publishers and matching the aggregated advertisements with advertiser demand. The fundamental difference between traditional media advertiser networks and online advertiser networks is that online advertise networks typically use a central advertising server to deliver advertisements to consumers, which enables analytics not possible with traditional media alternatives. In addition, publishers of online applications can generate some or all of their revenue through presenting advertisements on computing devices or by having users of the computing devices click on an advertisement or download an application associated with an advertisement. The present disclosure relates to advertisements configured to be presented to a user during execution of an application, including, but not limited to mobile applications. However, it is understood that certain embodiments disclosed herein can be used with any advertising network, such as a television ad network or a print ad network. Mobile device application advertisements may include, but are not limited to, banner ads (displayed at the top of the app) or poster ads (displayed at the bottom of the app), full-screen interstitials, or advertising within mobile games and mobile videos themselves.

In an embodiment, publisher 106 can be an entity that creates one or more applications (e.g., game, social networking, or video applications) to be downloaded to user devices, for example user device 104A-C. For example, a publisher may publish a single application, such as a football game application, or a suite of applications, such as a suite of document processing applications. In an embodiment, publisher 106 can also be configured to create advertisements for one or more application to be included in other applications (e.g., an advertisement for the publisher's game app, to be displayed during execution of other game applications or within social networking applications). In an embodiment, these advertisements can be associated with the one or more additional applications. For example, the advertisement may be associated with a specific game application, or it may be associated with a suite of gaming applications. In, an embodiment, a user on a user device, for example user device 104A, can be using an application, for example an application produced by publisher 106. The user may, while using the application on the user device, be presented with an advertisement (e.g., a banner, poster, or full-screen interstitial ad).

In an embodiment, advertiser 108 can be configured to receive one or more advertisements or information identifying one or more advertisements, for example a list of advertisements. For example, advertiser 108 may receive an advertisement for a football game from a publisher or may receive information identifying advertisements for each application in a suite of sports game applications from a publisher. The advertiser 108 can be configured to send advertisements to applications running on a user device, for example user devices 104A-C. In an embodiment, advertiser 108 can be configured to send one or more advertisements to a specific application running on a specific user device, to more than one application running on a specific user device, to a specific application running on more that one user device, or to more than one application running some or all of which may be running on more than one user device. In one example, advertiser 108 may send a list of advertisements to be presented when a football application is executing on user device 104A. In another example, advertiser 108 may send a list of general advertisements to be presented in any application executing on user device 104A. In yet another example, advertiser may send a list of advertisements to be presented when a football application is executing on user devices 104A or 104B.

In an embodiment, advertiser network 110 can be configured to receive one or more advertisements from one or more publishers. This may include identification information about an application being advertised, classification information about the application being advertised, or other pertinent information. For example, a publisher may send advertiser network 110 an advertisement for a football application including information identifying that the application is a sports application, identifying it as an information application (if it provides information about football game) or a gaming application (if allows a user to play a mobile football game), target audience (say 14-35 year old men), information regarding other applications by this publisher, etc. The advertiser network may also have a pass through module, for example a software development kit, provided by an analysis server 112. Examples of this pass through module will be described in more detail below.

In an embodiment, the analysis server 112 is configured to receive information, about one or more advertisements and applications, and provide a list of targeted advertisements. In an embodiment, the list can be an unordered grouping of advertisements. In an embodiment, analysis server 112 can provide information on the type of advertisements to be presented. For example, analysis server 112 can indicate that 3 sports advertisements and one gaming application should be presented in a football application. The process used to generate the list or grouping will be discussed in more detail below.

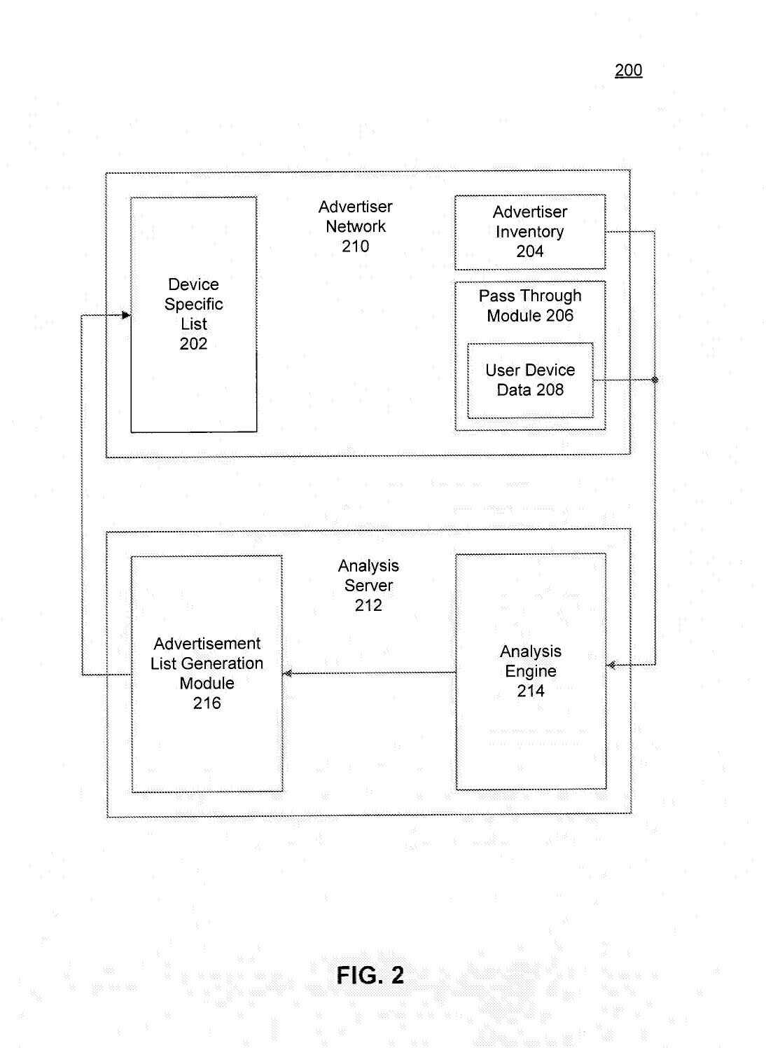

FIG. 2 illustrates an user-based analysis system 200 comprising an advertiser network 210, for example advertiser network 111 illustrated in FIG. 1, in communication with a analysis server 212, for example analysis server 112 illustrated in FIG. 1.

In an embodiment, advertiser network 210 is configured to receive a target application, possible advertisements, and/or advertisement/application data from publishers, for example publisher 106 illustrated in FIG. 1, and/or user device data from user devices, for example user devices 104A-C illustrated in FIG. 1, and return to an advertiser, for example advertiser 108 illustrated in FIG. 1, a list of advertisements specific to particular applications and/or to the user devices. In an embodiment, advertiser network 210 comprises a device specific list 202, advertiser inventory 204, and a pass through module 206. Pass through module 206 can comprise user device data 208.

In an embodiment, advertiser inventory 204 is configured to store one or more advertisements. In an embodiment, advertiser inventory 204 is configured to store advertisements from one or more publishers. For example, advertiser inventory 204 can store a pool of advertisements from one or more publishers grouped by publisher, such as Company X, Company Y, and/or Company Z. Advertiser inventory 204 can store a pool of advertisements from one or more publishers grouped by type of advertisement, such as advertisements for gaming applications, office applications, word processing applications, social media applications, health applications, music applications, news applications, etc. Advertiser inventory 204 can also store a pool of advertisements in bulk without any sort of categorization.

Advertisements can include additional information for example, promotions related to one or more applications produced by the publisher. Advertisements can contain information about the application, for example, the identification of the associated application, classification information about the application (e.g., is this office application for accounting, business development, marketing, etc.), target audiences (e.g. target age, gender, occupation, education, income, location, language, interests, etc.), similar advertisements, similar applications, etc. In an embodiment, when requested, the pool of advertisements and their associate information can be sent to analysis engine 214. In an embodiment, the pool of advertisements and their associate information can be sent to analysis engine 214 on a periodic basis, for example once an hour, once a day, or once a week.

In an embodiment, pass through module 206 is configured to send data to analysis engine 214. In an embodiment this data can include user device data 208. In an embodiment, pass through module 208 can be part of a software developer's kit (SDK). In an embodiment, pass through module 208 can be provided by the manufacturer and/or operator of the analysis server 212 and/or the analysis engine 214. For example, an analysis entity can design, manufacture, or operate analysis server 212 and/or the analysis engine 214. This entity can also provide a SDK to be installed in advertiser network 210, for example pass through module 206. The pass through module can be designed to collect user device data and pass it off to the analysis engine without accessing or modifying the data. Pass through module 206 can be designed to encrypt user device data or other data to ensure that the data is not accessed by unauthorized entities.

User device data 208 can comprise data and contextual information about a specific user device, for example industry accepted device identification, applications on the user device, applications downloaded to the user device from prior advertisements, advertisements previously sent to the user device, demographics about the user, location of the user, usage of the application on the user device, web applications on the user device, etc.

Pass through module 206 can also be configured to provide the application in which the advertisement will be inserted to analysis server 212 or analysis engine 214.

In an embodiment, advertiser network 210 can be configured to send additional data to analysis server 412 or analysis engine 214, for example user device data 208. In such an embodiment, the functionality of the pass through module can be handled by advertiser network 210, and additional data, for example user device data 208, can be sent to analysis engine 214 with the pool of advertisements or separately from the pool of advertisements.

In an embodiment, analysis server 212 is configured to receive an application, one or more advertisements, and/or user device data. For example, analysis server 212 could receive an indication that advertisements to be displayed in a football simulation game application are requested, a pool of advertisements from a publisher of sports related applications (game applications, ticket sales applications, team related memorabilia sales applications, game news/blogging applications, etc.), and information regarding the user device for example other applications on the user device, usage statistics (for example when the device is used, where the device is used, where the device owner lives, when specific applications are used, advertisements that have been clicked on in the past, services that have been requested, etc.). Analysis server 212 can be configured to return a list or other grouping of advertisements that would be of interest to users using, the application on the specific one or more user devices. In the above example, the list or other grouping may include advertisements for other sports game simulation applications and applications associated with, for example, sports teams in the area where the user device is most often used or where the owner of the user device lives. In an embodiment, analysis server 212 comprises an analysis engine 214 and an advertisement list generation module 216.

In an embodiment, analysis engine 214 can be configured to receive one or more pieces of data, for example, application identification information, one or more advertisements and associated information, and data, from one or more user devices. In an embodiment, application identification information can be the name of an application, characteristics about the application (e.g., is it a game application, is it a word processing application, who published it, etc.), or other information that may be useful for identifying other advertisements that may be of interest to users of the application. As discussed above, advertisements and associated information can include information about the advertised application (e.g., the identification of the associated application), classification information about the advertised application, target audiences, similar advertisements, similar applications, the number of advertisements requested, the size of the pool of random applications, etc. Data from one or more user devices can comprise any history of applications downloaded, any history of advertisements clicked on, any history on the usage patterns for applications (e.g., which ones have been used in the past month or past week, when applications are used), any information regarding applications where an advertisement has been clicked on, etc. In some embodiments, at least some of this data may be derived from an “app-sharing-app,” as described in further detail below.

In an embodiment, analysis engine 214 can be configured to analyze and score one or more of the advertisements. In an embodiment, the score is a value that ranges from −1 to 1 indicating the likelihood that the advertisement will be clicked on when the application is running on a specific user device. For example, a score of −1 can mean that the advertisement would never get clicked on if presented with a specific application on a specific user device, while a score of 1 can mean that it will always get clicked. This score can be associated with a specific device and/or a group of devices. For example, an advertiser might want to know which advertisement to send to an application, for example a football application, during the game, to all users in the New York City area at half time Or the advertiser may want to know what advertisement to send to a specific user at a specific time Analysis engine 214 can first remove advertisements for applications that are currently available on a user device, in an embodiment.

In an embodiment, analysis engine 214 can be configured to score advertisements based on data collected from one or more user devices in the past. For example, based on data collected, the analysis engine 214 may determine that, in the past, user devices with an application created by a specific publisher, for example publisher 106, were more likely to download other applications by that publisher (e.g., if the users had a good experience). Or that, in the past, user devices with an application created by a specific publisher were less likely to download other applications by that publisher (e.g., if the users had a bad experience). An analysis engine 214 can base this information off of publically available user models, privately collected and distributed user models, and/or user models developed by analysis engine 214 based on past data from user devices associated with it. In an embodiment, analysis engine 214 can be configured to score advertisements based on predefined logical rules. For example, analysis engine 214 may improve the score for advertisements for games when the advertisement will be shown within another gaming application. In yet another embodiment, the analysis engine may score advertisements based both on analytical rules and empirical evidence.

In an embodiment, advertisement list generation module 216 receives a collection of the advertisements, each associated with a specific score. The collection may also contain other information useful in creating a targeted list, for example a value associated with the payment made if an advertisement is clicked on. In an embodiment, advertisement list generation module 216 can generate a targeted list based on the likelihood that each advertisement will, be clicked on. The targeted list may contain all advertisements in the collection of advertisements, or may contain a subset of the advertisements. In an embodiment, advertisements may appear on the targeted list more than once. In an embodiment, the location of each of the advertisements in, the targeted list may, in addition, be based on the value associated with each advertisement. In an, embodiment, a randomness factor may also be included that may move advertisements onto, off of, up, or down the targeted list. In one embodiment, the targeted list may contain the relative number of times a specific advertisement should be shown, for example if advertisement A is on the list 3 times and advertisement B is on the list once, then advertisement A should be shown in the application on the user device three times more often than advertisement B. In another embodiment, the targeted list may contain the advertisements in the order they should be shown. For example a targeted list with advertisements A-E may contain A, C, A, B, E. In this example, the advertisements should appear in the application in the order specified. Some advertisements, like advertisement A may appear more than once, and some, like Advertisement D, may not appear at all.

In an embodiment, device specific list 202 is configured to maintain a list of targeted advertisements. As discussed above, these targeted advertisements can be for one or more than one application on one or more than one user device, for example all user devices that match a specific criterion like located within, a given area code, zip code, or other geographical boundary. In an embodiment, the list of advertisements can be an ordered list of advertisements that a user of the device is most likely going to click on. In an embodiment, the targeted list can be in a random ordering. In an embodiment, some elements may be ordered, such as by their likelihood to be of interest to a user, and some elements may be randomly ordered.

In an embodiment, information transmitted between advertiser network 210 and analysis server 212 can be encrypted. In an embodiment, advertiser network 210 and analysis server establish an encryption, procedure prior to communication information. For example, this may include transmitting one or more public or private keys, accessing a database of encryption keys, or other methods known to people skilled in the art.

In an embodiment, the request for advertisements and the transmittal of a list or grouping of advertisements can happen in real-time or substantially close to real-time. For example, a user device or advertiser may request a list of advertisements that a user has started using and analysis server 212 and advertiser network 210 can provide that list with little or no noticeable delay by the user device.

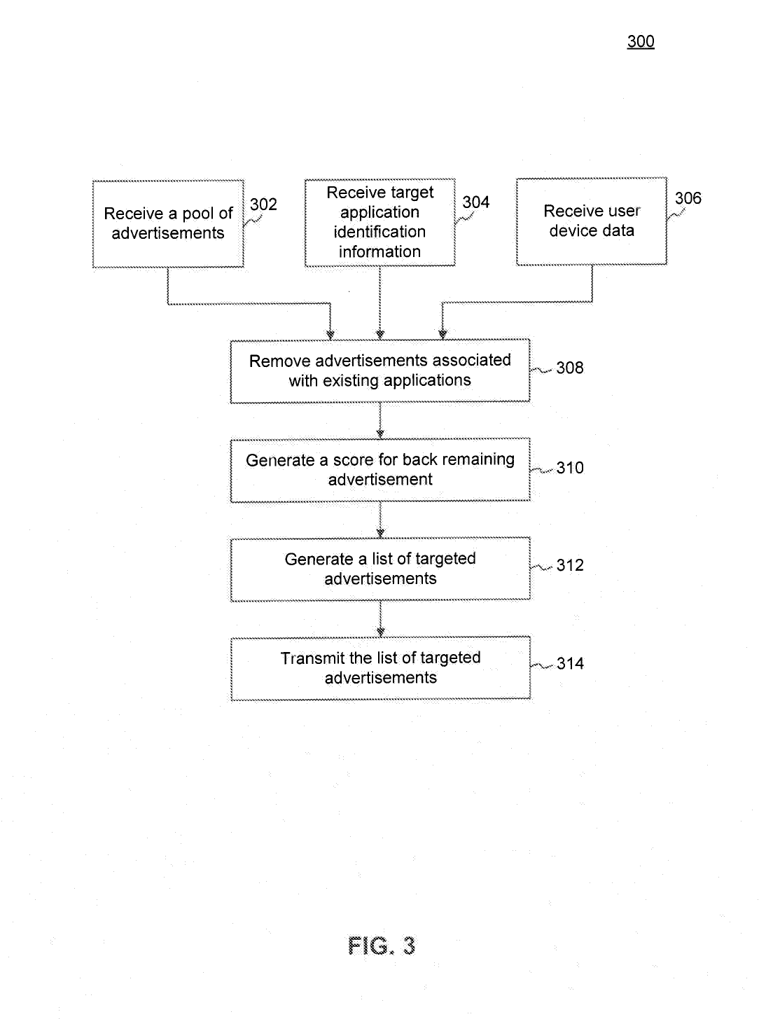

FIG. 3 is a flowchart illustrating a process 300 for a device, for example an analysis server, to create a targeted list or grouping of advertisements, according, to an example embodiment. In the discussion below, FIG. 3 is described in terms of an example method for an analysis server (e.g., analysis server 212 in FIG. 2) receiving advertisements and additional information, processing the information, and creating a targeted list of advertisements. Those skilled in the art would understand that devices other than an analysis server could implement these steps without departing from this description. For example, the structures and function described herein for some embodiment as being part of or executed by the analysis server may be part of or executed by the advertising network—or vice versa. Those skilled in the art would also understand that the steps outlined in FIG. 3 do not need to be executed in the order illustrated or described and that some steps may be skipped an others added without deviating from the disclosed embodiments.

At step 302, the analysis server can receive a pool of advertisements that consists of some or all of the pool of advertisements in an advertisement network that can be published. For example, the first time the analysis server receives the pool of advertisements, it may receive them all. In the future, it may only receive an updated copy, for example identifying new advertisements, identifying deleted advertisements, and/or identifying changes in information for one or more advertisements. In another example, the analysis server may only receive a partial list of advertisements, for example advertisements for free applications or advertisements with a click through value (e.g., the price paid to an advertiser if an advertisement is clicked or an application is downloaded) above a set threshold. The list of advertisements can include identification information for each of the advertisements in the pool. In an embodiment, the list of advertisements can include additional information about each advertisement, such, as the application it is associated with, any characteristic information about the application of the advertisements, suggested target audiences, etc.

At step 304, the analysis server can receive identification information regarding a target application. In an embodiment, the target application is the application that will eventually present one or more advertisements to a user. The identification information can include information to identify the application itself, the publisher of the application, information about the application (classification, publication date, cost, target audience, etc.), and other information that may be useful in identifying pertinent advertisements (e.g. recipient target age, gender, occupation, education, income, location, language, interests, etc.).

At step 306, the analysis server can receive other user device data. In an, embodiment, the other user device data can include information about the user device itself, other applications that are on the user device, applications that were downloaded in the past and have since been removed, usage statistics for the applications and the device, statistics regarding the other applications (e.g., has a user paid for additional services), advertisements that have been clicked on at the user device in the past, information regarding different user accounts, etc. User device data can be for a single user device or can be from multiple user devices. For example, the user device data can be for all user devices associated with a specific account (for example a mobile phone account) or all user devices in a specific area with the target application on them.

At step 308, the analysis server can remove advertisements associated with existing applications. In an embodiment, because a user is unlikely to download or be interested in advertisements for applications that the user already has on their user device, the analysis server can remove any such advertisements from the pool of advertisements.

At step 310, the analysis server can generate a score for each advertisement that remains in the pool of advertisements. In an embodiment, this score can be adjusted based on analytic rules, for example affinity relationships. For example, the analysis server may implement a rule that if the target application is a gaming application, the score for all advertisements for other gaming applications increase or the score for all office applications decrease. In an embodiment, the analysis server may adjust the score based on information about the device.

For example, the analysis server may reduce the score if the associated application was previously downloaded and has since been deleted or based on the location of the user device, or the time of day the advertisement will be displayed. In an embodiment, the score can also be adjusted based on empirical evidence and analysis of that evidence. In an embodiment, the score can be affected by data collected regarding this device and other devices in the past. For example, if users in the past often delete an application, for example a football application, after an event, for example in February after the season is over, and then download the application again at a later date, for example in August when the next season begins, the analysis server may determine that the score for an advertisement for this app may be based on the time of the year.

In an embodiment, analysis server 212 can also adjust the score based on past actions by the analysis server itself, for example maintaining information on advertisements presented to a user device in the past, like the number of times presented and when the advertisement was last presented. In an embodiment, the score can also be affected by applications pushed to other user devices from the one or more user devices or, applications pulled from other user devices. For example, if the user has pushed a football application to other people, the score for advertisements for other sporting applications may be increased. In an embodiment, the score may also be based on the history received from other user devices. For example, if a specific user device receives a lot of pushed office management applications, the score for advertisements for additional office management applications may be increased.

In an embodiment, the score can be based on both analytical rules and empirical evidence. In an embodiment, adjustments may be based on the combination of analytical rules and empirical evidence. For example, the analytical rule may require adjusting the score for advertisements of applications by the same publisher as the target application, but the amount of the adjustment may be determined by empirical evidence.

In an embodiment, the score can range from −1 to 1. For example, −1 can indicate that a user never click on a specific advertisement on a user device in an application, and a 1 can indicate that a user will always click on that advertisement on that user device when presented in that application.

At step 312, the analysis server can generate a list or grouping of targeted advertisements. In an embodiment, this list or grouping can include some or all of the advertisements in the received pool of advertisements. In an embodiment, these advertisements may appear more than once in the list or grouping of targeted advertisements. In an embodiment, the list or grouping may be generated based on the score each advertisement received in step 310. In an embodiment, the list is an ordered list indicating the order in which advertisements should appear in the application. In another embodiment, the list or grouping is unordered, i.e., the list or grouping only indicates which advertisements to show and at what frequency. The list or grouping may also be based on a random factor that may move advertisements up or down the ordered list, or on or off of either the ordered list or unordered list or grouping.

At step 314, once the list or grouping of targeted advertisements is generated it can be transmitted to the appropriate place. This can include storing the list or grouping to common memory, communicating the list or grouping over a network to another entity, for example an advertisement network, etc.

In an embodiment, some or all of the above steps can happen on a periodic basis. For example, once a day the analysis server can receive updated information, generate scores for the provided advertisements, generate a list or grouping of targeted advertisements, and transmit that list or grouping.

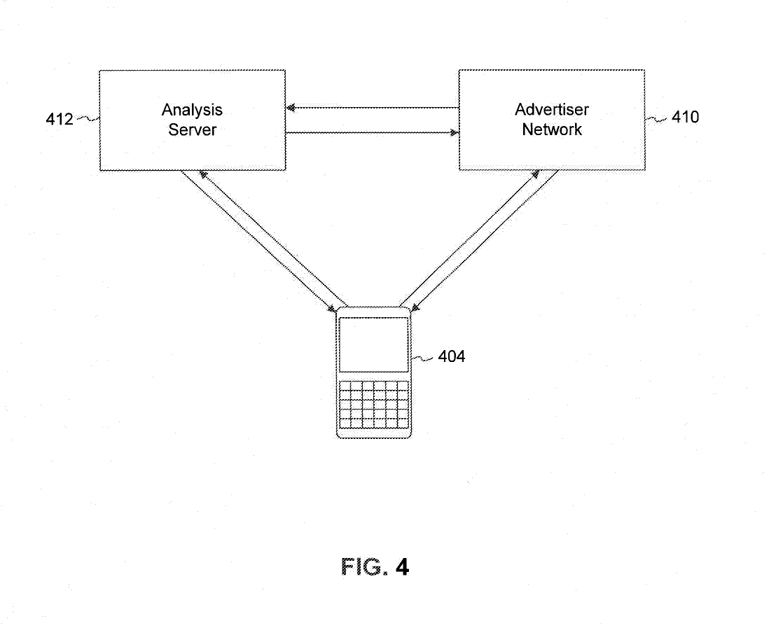

FIG. 4 illustrates an environment 400 in which embodiments can be implemented. Environment 400 comprises user device 404, advertisement network 410, and analysis server 412.

User device 404 is a computing device configured to communication with advertisement network 410 and analysis server 412. For example, user devices 404 can be a personal computer, laptop, cell phone, tablet, television, wearable computing device, etc. User device can be, for example, one of user devices 104A-C.

Environment 400 is configured similarly to environment 100 illustrated in FIG. 1. But, unlike analysis server 112, analysis server 412 can be configured to communicate with user device 404.

In an embodiment, analysis server 412 is configured to receive advertisement information and user data from the advertisement network 410, as described above with analysis server 212 and advertisement network 210. In an embodiment, analysis server 412 can be configured to also receive user device data and application data from user device 404. In an embodiment, analysis server 412 can be configured to generate a list or grouping of targeted advertisements for a specific application running on user device 404. Analysis service 412 can be configured to provide advertisements directly to user device 404, or provide a list or grouping of targeted advertisements to user device 404.

In addition, analysis server 412 can be configured to periodically collect user device data from user device 404. This data can be used to generate more accurate lists of targeted advertisements. This data can also be stored and used in the future to generate lists for other user devices. For example, analysis server 412 can be connected to 100 user devices. Over a year, analysis server may collect enough information to more accurately predict what advertisements will be most effective for these user devices. In another embodiment of the present invention, the structures and function described herein for some embodiment as being part of or executed by the analysis server 412 may be part of or executed by the advertising network 410—or vice versa. In an embodiment, the analysis server 412 and the advertising network 410 may be combined into a single structural or functional unit, such that the analysis server 412 and the advertising network 410 are one in the same structurally and/or functionally the same.

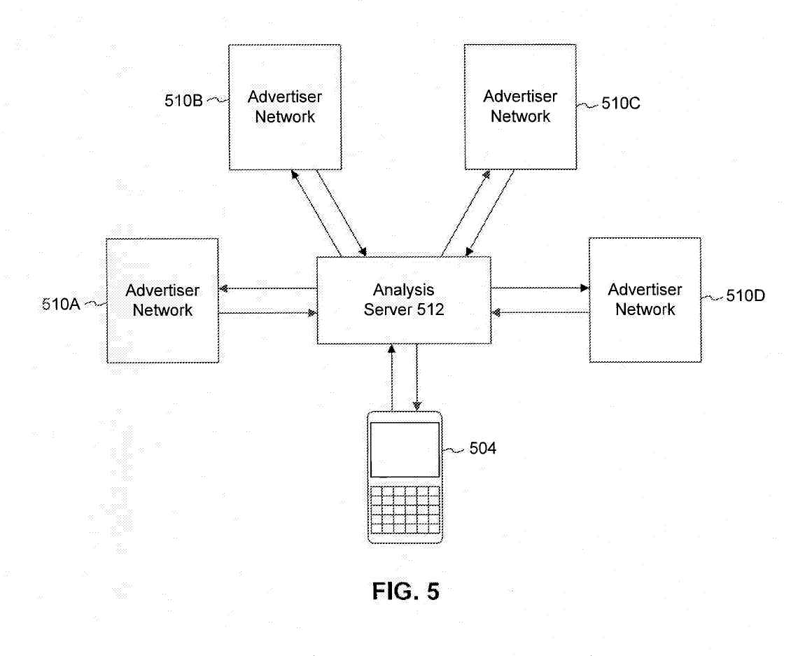

FIG. 5 illustrates an environment 500 in which embodiments can be implemented. Environment 500 comprises user device 504, advertisement networks 510A-D, and analysis server 512.

User device 504 is a computing device configured to communication with analysis server 512. For example, user devices 504 can be a personal computer, laptop, cell phone, tablet, television, wearable computing device, etc. User device can be, for example, one of user devices 104A-C.

Environment 500 is configured similarly to environment 100 illustrated in FIG. 1. But, unlike analysis server 112, analysis server 512 can be configured to communicate with multiple advertisement networks 510A-L.

In an embodiment, analysis server 512 is configured to receive one or more pools of advertisements from advertisement networks 510A-D. Each network may be connected to one or more publishers. In an embodiment, advertisement networks can be associated with different characteristics of applications. For example, one network may contain pools of advertisements for businesses local to San Jose and another network may contain pools of advertisements for applications that are free to download.

In an embodiment, analysis server 512 can receive pools of advertisements from one or more advertisement networks 510A-D. It may receive some of the pools on a periodic basis. In an embodiment, analysis server 512 can be configured to combine one or more of the pools of advertisements into larger pools. In an embodiment, analysis network can be configured to remove duplicate advertisements. In some embodiments, the analysis server 512 may be able to benchmark the performance of one advertising network against another and provide analytical data about advertising network relative performance. For example, reports could be generated and distributed on relative advertising network performance. Analytical data examined could include, for example, data on applications downloaded based on advertisements or data on advertisements served, any data on advertisements clicked on, any data on the usage patterns for applications (e.g., which ones have been used in the past month or past week, when applications are used) related to advertisements, any information regarding applications where an advertisement has been clicked on, etc.

In one embodiment, the analysis engine 214 of the analysis server 212 may draw upon data collected via an application created for sharing other applications to assist in the analysis. Analysis server 212 can be configured to periodically collect user device data from user device 104A-C. This data can be used to generate more accurate lists or groupings of targeted advertisements. This data can, also be stored and used in the future to generate lists for other user devices. Over time, analysis server may collect enough information to more accurately predict what advertisements will be most effective for these user devices.

Oftentimes, users download particular applications based on word of mouth referrals from friends and family. However, finding a certain application in an app store using the app store's default search capabilities can still be a challenge, as there is often a multitude of applications that can perform a particular function or have similar names. An application created for sharing other applications (also referred to herein as an “app-sharing-app”) may enable users to identify, discover, share, refer and download desired apps quickly and easily and provide information to an analysis engine to more accurately score advertisements.

In certain embodiments, the app-sharing-app can include features to facilitate application sharing. In an embodiment, the app-sharing-app can be configured to migrate an application from one device to another. For example, when a user device is purchased; at a point-of-sale location, the retailer may migrate one or more applications to the user device, using data derived from the app-sharing-app and stored locally on the user device, at an analysis server, and/or with the retailer or associated service provider (e.g. a wireless carrier). Or, when connected to a wireless carrier, the carrier may migrate one or more applications to the user device.

In an embodiment, the app-sharing-app can be configured to handle cross platform sharing and transfer. As described below, user devices can share applications with other user devices that are “friends” with them or that are following them. Some of these user devices may be using a different platform (e.g. Android, iOS, Windows Mobile, etc.). In those instances the app-sharing-app can identify the correct, applications for each platform, and download transfer the applications accordingly. For example, if a user device is a Android wireless communication device using the Android OS and is trying to transfer an application to a user device using the Apple iOS, the app-sharing-app can be configured to identify the platform incompatibility, download the correct version of the applications from the supplier or app store, and push or transfer the correct version of the application to the subscriber user device.

In certain embodiments, the app-sharing-app can include features of social media platforms. For example, a user can have “fiends”, who can be other users of the app-sharing-app that have agreed to allow the user to see their shared apps, and who can see the shared apps of the user. Users can “follow” other users, whereby the following user can receive updates about another followed user's activity, for example, which new apps the followed user has recently downloaded or recommended. A user can also be “followed” by other users. In certain embodiments, a followed user must allow another user to follow them, for example, by accepting a request to be followed, before information relating to their activity will be sent to the other user. In certain embodiments, the app-sharing-app allows the user to select which actions are shared with followers or friends. In certain embodiments, users can create “collections” of multiple apps in order to better organize apps on their device. It is envisioned that the app-sharing-app can also be used for sharing other types, of media, for example, music, books, movies, and photos.

Data derived from these social features of the app-sharing-app may be used to allow the analysis server to collect enough information to more accurately predict what advertisements will be most effective for these user devices.

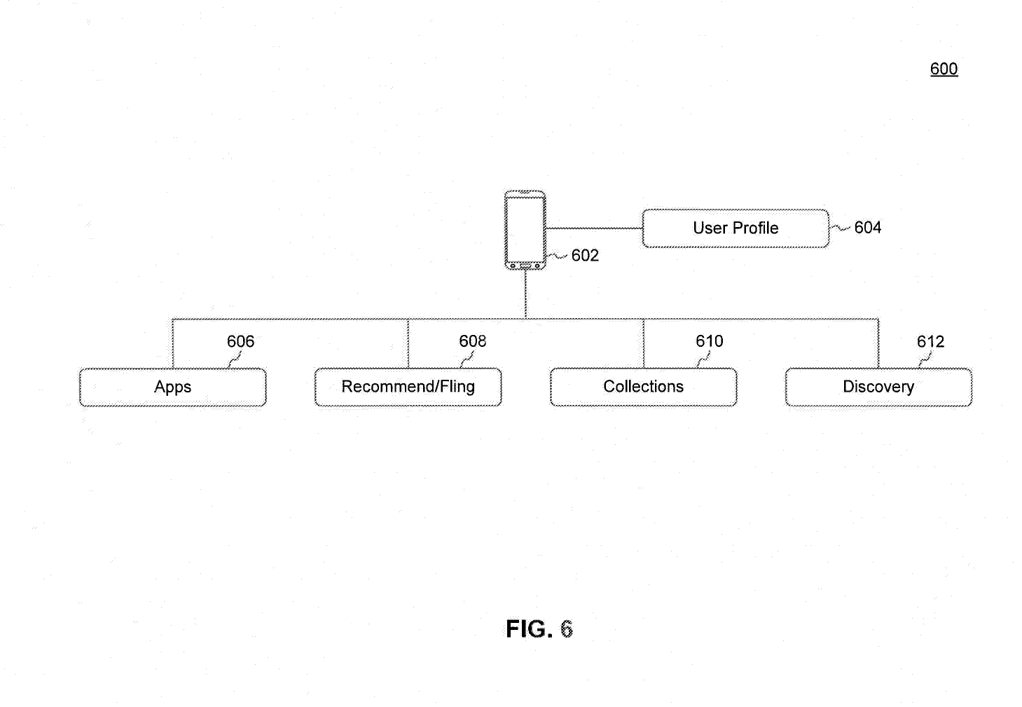

The functionalities and capabilities of various embodiments of the app-sharing-app will be explained with reference to FIGS. 6-11. Components and features of a suitable app-sharing-app may include, for example, those disclosed in commonly owned U.S. Provisional Patent Application No. 61/748,257, filed Jan. 2, 2013, which is hereby incorporated herein by reference in its entirety.

FIGS. 6-11 show flow charts for various functions of an exemplary app-sharing-app (referred to in FIGS. 6-11 as “Appy”), according to embodiments. FIG. 6 shows core functions of the app-sharing-app, according to an embodiment. User device 602 can have the app-sharing-app installed on it. In module 604, the user can create a profile and set privacy controls. User device 602 can have one or more additional applications stored on it. The app-sharing-app can scan the user's device for apps in module 606 and organize them into categories in module 610. The user can then decide which apps to share publicly in module 608. Also in module 610, the user can create and manage collections of apps outside of the default categories of the app-sharing-app. The app-sharing-app can provide an interface for the user to recommend apps to other users in module 608. In certain embodiments, module 608 allows apps to be “flung” to other users within a certain proximity. Users can also search for other apps based on certain search criteria in module 612.

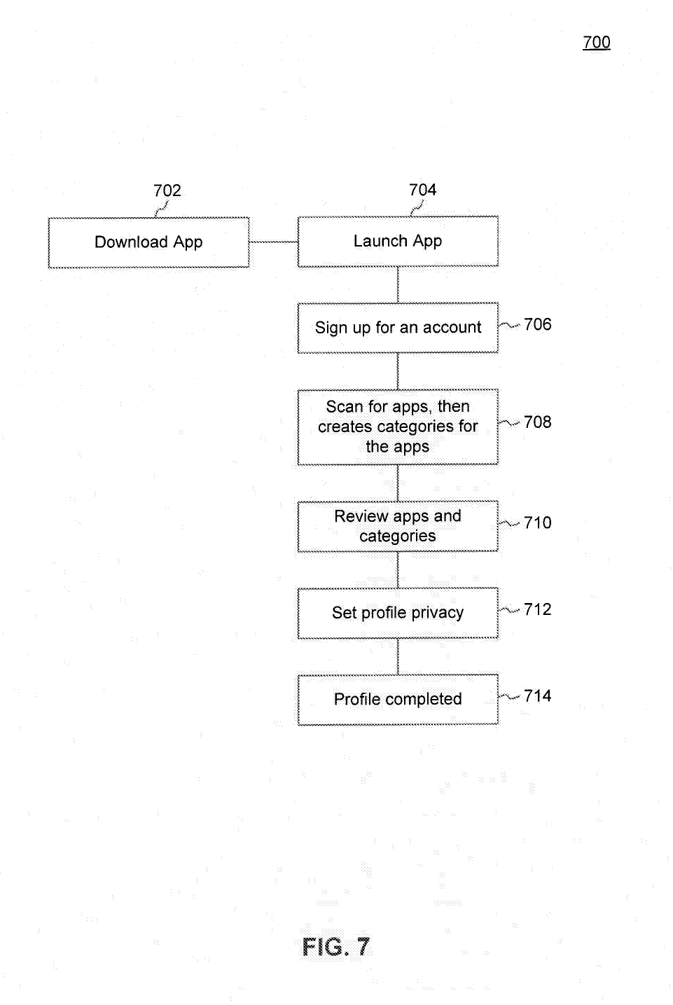

FIG. 7 shows a flow chart for setting up an app-sharing-app account. After downloading the app-sharing-app at step 702, the user can launch the app-sharing-app at step 704 and choose to sign up for an account at step 706. The user can enter information such as a username, associated email, and password at step 706. At step 708, the app-sharing-app can then perform a scan to detect apps on the user's device. In certain embodiments, the app-sharing-app can organize the detected apps into categories, for example, Finance, Games, or News. At step 710, the user can review the detected apps and categories and, at step 712, mark apps as either shared or private. The user can also mark entire categories as private. In certain embodiments, only shared apps can be put into collections, whereas private apps cannot. Users can still have the ability to recommend or “fling” both shared and private apps to other users. Users can also select whether to have a public or private app-sharing-app user profile. Public profiles can be viewed by all other app-sharing-app users. Private profiles can be viewed only by friends of the user. Apps marked as private cannot be viewed by other users, even friends. At step 714, once the user has finished setting up an account, the user can receive an email confirmation and proceed to the home screen.

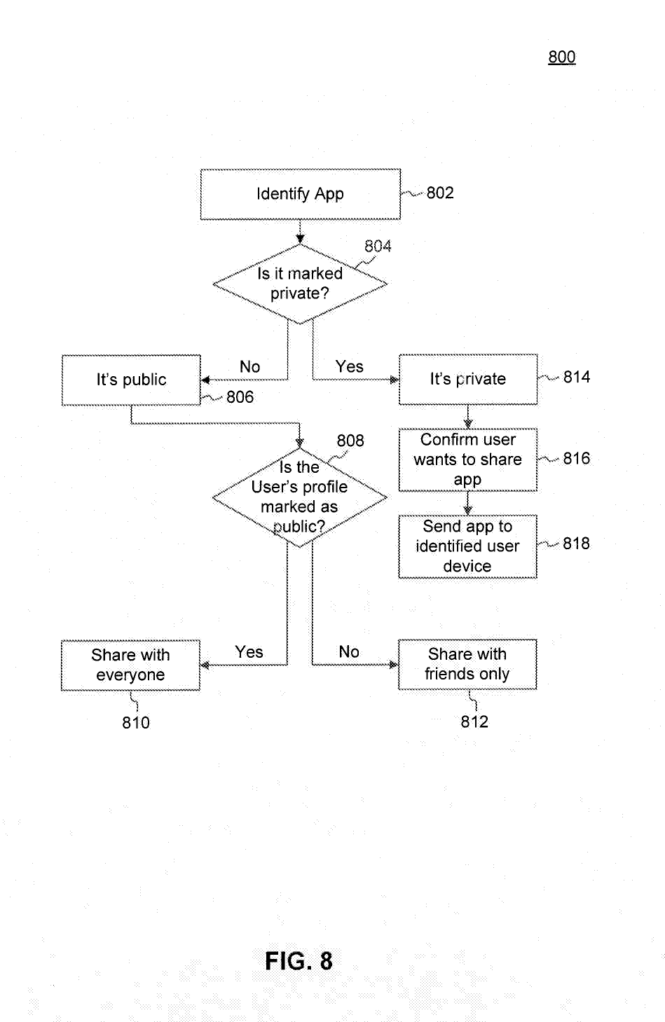

FIG. 8 shows a flow chart for determining which apps are shared, according to an embodiment. At step 802, an app is identified. In certain embodiments, at step 804, if an app is marked as private (step 814), it is not visible in a user's profile. In certain embodiments, it also cannot be added to a collection. In certain embodiments, a private app can still be recommended or “flung” to another user. For example, at step 816, the user can be asked to confirm that they want to share, a private app. If so, then at step 818, the app can be sent to a specified user device or group of user devices. If an app is designated as shared (step 806), it is visible in a user's profile, can be added to collections and recommended or flung to other users. At step 808, certain embodiments determine if the app is marked public. If a user has a public profile, shared apps are viewable by all other users at step 810. If a user has a private profile, shared apps are only viewable by friends of the user at step 812.

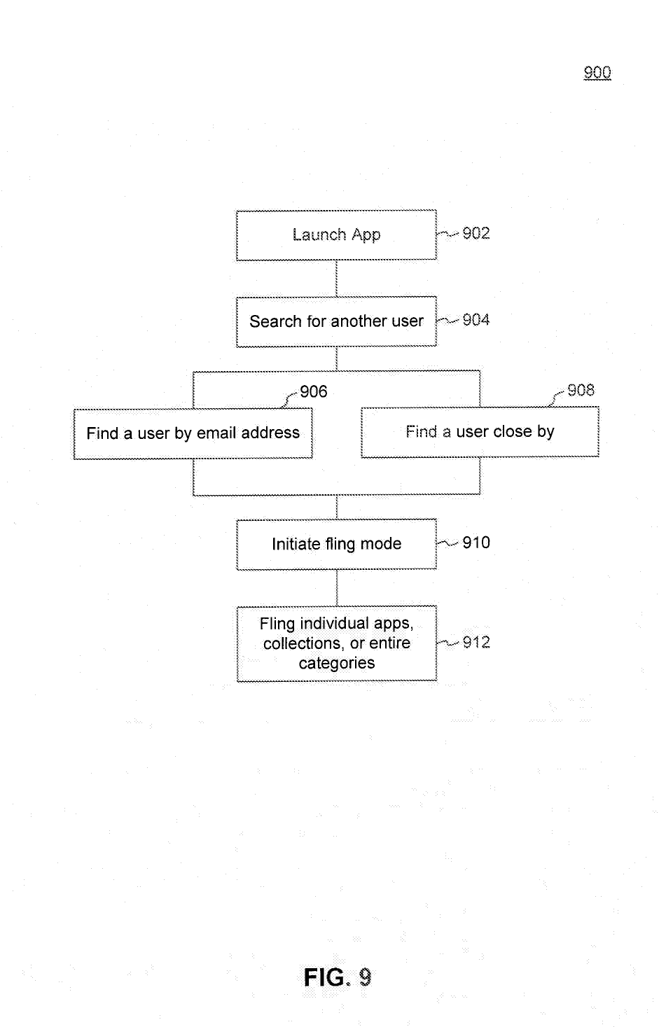

FIG. 9 shows a flow chart for recommending an app, according to an embodiment. After launching the app-sharing-app at step 902, a user can search for another user at step 904, for example, by entering a username or email address at step 906. In certain embodiments, the app-sharing-app can detect other users within a certain proximity of the user's device at step 908. In certain embodiments, recommended apps can be sent to the other user's email address. In certain embodiments, at step 910 users can initiate a “fling mode”, where a direct connection can be made between users such that, at step 912, recommended apps can be “flung” from one, user to another in substantially real time using appropriate local or personal area networking or wireless transmission protocol technologies. Individual apps, collections or entire categories of apps can be recommended or flung to another user.

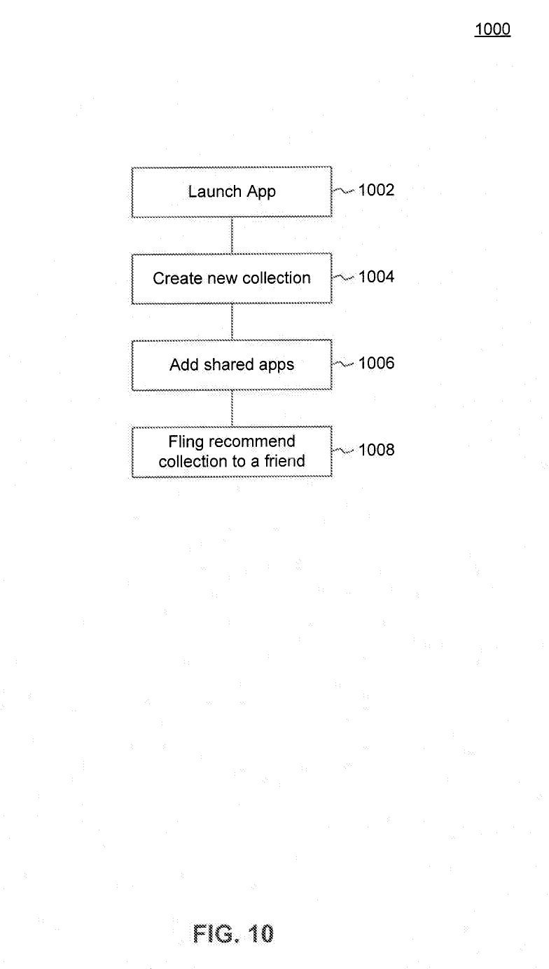

FIG. 10 shows a flow chart for creating a collection of apps, according to an embodiment. After launching the app-sharing-app at step 1002, the user can select to create a new collection at step 1004. At step 1006, the user can name the collection and select which apps to add to the collection. Apps can be placed into multiple collections. In certain embodiments, only apps marked as shared can be added to collections. If the user has a public profile, the user's collections can be viewed by all other app-sharing-app users. If the user has a private profile, the user's collections can only be viewed by the user's approved friends. At step 1008, the entire collection can be recommended to other users.

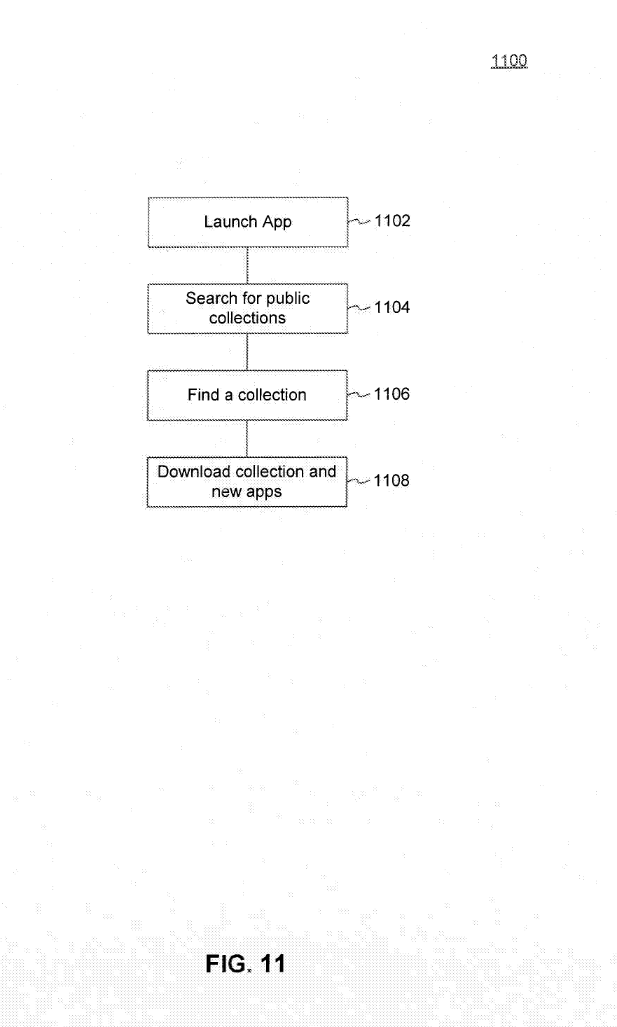

FIG. 11 shows a flow chart for discovering new apps or collections, according to an embodiment. After launching the app-sharing-app at step 1102, the user can search publicly shared apps or collections as well as apps and collections shared by friends at step 1104. The user can enter one or more keywords to search for collections containing that word or words. Additional search criteria or algorithms can be used to find relevant apps, and results can be sorted using additional data at step 1106. For example, search results can be sorted by location of the other user or based on the number of times an app has been recommended to other users. The user can review the search results and download apps or collections to the user's own device. At step 1108, the user can designate the new app as shared or private and choose to add it to one or more collections.

In some embodiments of the present invention, data collected about users of the app sharing app can be used to, generate more accurate lists or other groupings of targeted advertisements. This data can also be stored and used in the future to generate lists for other user devices. Over time, analysis server may collect enough information to more accurately predict what advertisements will be most effective for these user devices.

In an embodiment, a method comprises receiving data associated with one or more user computing devices, wherein the data comprises the identity of an application stored on one or more of the one or more user computing devices, receiving a pool of advertisements, wherein an advertisement in the pool of advertisements comprises advertisement information associated with the advertisement, analyzing the data, the pool of advertisements, and the advertisement information to identify one or more suitable advertisements for presentation to the one or more of the one or more user computing devices, and sending information comprising an identification of the one or, more suitable advertisements.

In another embodiment, a method comprises receiving data associated with a user computing device, wherein the data comprises the identity of an, application stored on the user computing device, receiving a pool of advertisements, wherein an advertisement in the pool of advertisements comprises advertisement information associated with the advertisement; analyzing the data, the pool of advertisements, and the advertisement information to identify one or more suitable advertisements for presentation to the user computing device, and sending information comprising an identification of the one or more suitable advertisements.

In a further embodiment, a method comprises receiving data associated with a plurality of user computing devices, wherein the data comprises the identity of an application stored on the plurality of user computing devices, receiving a pool of advertisements, wherein an advertisement in the pool of advertisements comprises advertisement information associated with the advertisement; analyzing the data the pool of advertisements, and the advertisement information to identify one or more suitable advertisements for presentation to the plurality of user computing devices, and sending, information comprising an identification of the one or more suitable advertisements.

In one embodiment, a system comprises a user device configured to store and execute one or more executing applications, a publisher configured to publish one or more advertisements, wherein the one or more advertisements are associated with one or more published applications, an advertiser configured to transmit one or more advertisements to one or more of the one or more executing applications executing on the user device, an advertiser network configured to receive data identifying the one or more advertisements from the publisher, receive user data from the user device, and send data identifying targeted advertisements to the advertiser, comprising a pass through module that is configured to receive the user data from the user device and transmit the user data to an analysis server, and the analysis server, which is configured to receive the user data from the user device and the data identifying one or more advertisements from the advertiser network and generate the data identifying targeted advertisements.

In another embodiment, a system comprises a user device configured to store and execute an executing application, a publisher configured to publish an advertisement, wherein the advertisement is associated with a published applications, an advertiser configured to transmit the advertisement to the executing application executing on the user device, an advertiser network configured to receive data identifying the advertisement from the publisher, receive user data from the user device, and send data identifying a targeted advertisement to the advertiser, comprising a pass through module that is configured to receive the user data from the user device and transmit the user data to an analysis server, and the analysis server, which is configured to receive the user data from the user device and the data identifying an advertisement from the advertiser network and generate the data identifying a targeted advertisement.

While the invention has been particularly shown as described with reference to a preferred embodiment, it will be understood by those skilled in the art that various changes in form and detail may be made therein without departing from the spirit and scope of the invention. For example, it will be appreciated that the concepts disclosed herein may be extended or modified to apply to other types of configuration entities having different rules than the particular exemplary embodiments disclosed herein. In addition, although aspects of the present invention have been described with respect to a computer system executing software that directs the functions of the present invention, it should be understood that present invention may alternatively be implemented as a program product for use with a data processing system. Programs defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention.

1. An advertisement analysis method for an analysis server to identify one or more suitable advertisements for presentation on one or more user computing device, comprising:
receiving, by the analysis server, data associated with the one or more user computing devices, wherein the data comprises an identity of an application stored on one or more of the one or more user computing devices;
receiving, by the analysis server, a pool of advertisements, wherein an advertisement in the pool of advertisements comprises advertisement information associated with the advertisement;
analyzing, by the analysis server, the data, the pool of advertisements, and the advertisement information to identify the one or more suitable advertisements for presentation to the one or more of the one or more user computing devices; and
sending, by the analysis server, information comprising an identification of the one or more suitable advertisements.

2. The method of claim 1, wherein the identification of the one or more suitable advertisements is sent to a mobile advertising network.

3. The method of claim 1, wherein the one or more user computing devices are mobile devices.

4. The method of claim 1, wherein the data comprises all applications stored on the one or more of the one or more user computing devices.

5. The method of claim 1, wherein the advertisement information comprises the identity of the application.

6. The method of claim 1, further comprising receiving, by the analysis server, advertisement list information comprising one of a number of advertisements to be returned, an indication of how random the advertisement should relate to the data, a ratio between a number of new advertisement and old advertisements, and a side of the advertisement pool used to select random advertisements from; wherein the analyzing further comprises analyzing the advertisement list information.

7. The method of claim 1, wherein the analyzing is done while the application is active on the one or more of the one or more user computing devices.

8. The method of claim 1, wherein the sending is done while the application is active on the one or more of the one or more user computing devices.

9. The method of claim 1, wherein the receiving happens on a periodic basis.

10. The method of claim 1, wherein analyzing further comprises removing advertisements associated with applications that are present on the one or more of the one or more user computing devices from the pool of advertisements.

11. The method of claim 1, wherein analyzing further comprises organizing the pool of advertisements based on a highest probability of download.

12. The method of claim 1, wherein analyzing further comprises analyzing suggestions from one or more additional user computing devices.

13. The method of claim 1, wherein analyzing is based at least in part on past data from the one or more of the one or more user computing devices.

14. The method of claim 1, wherein receiving the pool of advertisements comprises receiving the pool of advertisements from an advertisement network.

15. The method of claim 1, wherein receiving the data further comprises receiving the data from an advertisement network.

16. An advertisement analysis device configured for determining a score for one or more advertisements in a pool of advertisements and generating a targeted list of advertisements based on the score, comprising:
an analysis engine configured to receive user data and the pool of advertisements, and determine the score for one or more advertisements in the pool of advertisements, wherein the pool of advertisements comprises the one or more advertisements and additional information for one or more of the one or more advertisements; and
an advertisement list generation module configured to receive the one or more advertisements and generate the targeted list of advertisements based on the score of the one or more advertisements.

17. The device of claim 16, wherein generating the targeted list further comprises modifying a placement of an advertisement based on a random effect.

18. The device of claim 16, wherein determining the score further comprises using analytical rules.

19. The device of claim 16, wherein determining the score further comprises using empirical analysis.

20. An advertisement analysis system configured for generating data identifying targeted advertisements based on data identifying advertisements and user data, comprising:
a user device configured to store and execute one or more executing applications;
a publisher configured to publish one or more advertisements;
an advertiser configured to transmit the one or more advertisements to one or more of the one or more executing applications executing on the user device;
an advertiser network configured to receive data identifying the one or more advertisements from the publisher, receive the user data from the user device, and send the data identifying the targeted advertisements to the advertiser, comprising a pass through module that is configured to receive the user data from the user device and transmit the user data to an analysis server; and
the analysis server, which is configured to receive the user data from the user device and the data identifying the one or more advertisements from the advertiser network and generate the data identifying targeted advertisements.

21. The system of claim 20, wherein the one or more executing applications includes an application created for sharing applications (“app-sharing-app”).

22. The system of claim 21, wherein the app-sharing-app is configured to display a shared one or more applications stored on a second user device.

23. The system of claim 22, wherein the app-sharing-app is configured to store, on the user device, one or more new applications selected from the shared one or more applications.

24. The system of claim 21, wherein the user device is further configured to utilize a first platform and wherein the app-sharing-app is configured to share the one or more executing applications with a second user device configured to utilize a second platform.

25. An advertisement analysis device configured for managing a list of one or more advertisements associated with user computing devices, comprising:
an advertisement inventory configured to store a pool of advertisements including information associated with the advertisements;
a pass-through module configured to store data associated with one or more user computing devices; and
a device specific list configured to store the list of one or more advertisements associated with one or more of the one or more user computing devices;
wherein:
the advertisement inventory and pass-through module are configured to transmit the pool of advertisements and the data to an analysis server; and
the device specific list is configured to receive the list from the analysis server.
